(19) United States
(12) Patent Application Publication
(10) Pub. No.: US 2022/0088643 A1
(43) Pub. Date: Mar. 24, 2022

(54) DISPOSABLE HYGENIC CLEANING MITT

(71) Applicant: Sally Ann Weithman, Rotonda West, FL (US)

(72) Inventor: Sally Ann Weithman, Rotonda West, FL (US)

(21) Appl. No.: 17/025,437

(22) Filed: Sep. 18, 2020

(51) Int. Cl. B08B 1/00; A41D 19/01; B08B 3/08; A47K 7/02

(52) U.S. Cl. CPC B08B 1/006; A41D 19/01; B08B 3/08; B08B 1/002; A41D 2300/33; A41D 2400/52; A41D 2600/20; A41D 2300/328; A41D 2300/32; A47K 7/02

(57) ABSTRACT

A disposable cleaning mitt includes a waterproof inner layer having proximal and distal ends and defining a pliable cavity configured to encase a wearer's hand. The inner layer includes an opening at the proximal end for passing the wearer's hand therethrough to enter and exit the cavity. A cleaning layer is disposed on the inner layer such that the inner layer is between the cleaning layer and the cavity. A tab is situated and accessible from inside the cavity, the tab being operatively coupled to the inner layer and the cleaning layer such that passing the tab through the opening inverts the inner layer and the cleaning layer and undelineates the cavity. The tab is configured to be pulled by at least one finger of the wearer's hand. A fastener is positioned adjacent the opening for sealing the cleaning layer inside the inner layer.

### BACKGROUND OF THE INVENTION

This invention is directed to cleaning devices and, more particularly, to a cleaning mitt that is wearable on a user's hand as a cleaning mitt and that is hygienic and disposable by inverting and sealing the mitt after use. Specifically, the hygienic mitt of the present invention includes a tab positioned inside an interior cavity that may be pulled so as to pull the mitt inside-out before sealing the interior for disposal.

The cleaning of a kitchen counter, toilet, or a medical patient is typically undertaken using a washcloth or cleaning wipe—either of which quickly become crumpled up or folded beyond usefulness. In addition, some have proposed a cleaning mitt wearable on the hand of a person using the mitt for cleaning. Although presumably effective for their intended purpose, the existing cleaning products and proposals do not account for proper hygienic disposal of the article that becomes soiled.

Therefore, it would be desirable to have a disposable cleaning mitt that is wearable on user's hand so as to provide a sturdy cleaning article. Further, it would be desirable to have a disposable cleaning mitt that includes an internal tab that enables the mitt to be turned inside out (i.e. to be inverted) after use so that collected debris wrapped away from exposure to other clean surfaces. In addition, it would be desirable to have a disposable cleaning mitt having an adhesive fastener situated about an open wrist opening that may be operated to seal a soiled and inverted mitt for purposes of disposal. Thus, the cleaning mitt is truly hygienic.

### SUMMARY OF THE INVENTION

A disposable cleaning mitt according to the present invention includes a waterproof inner layer having proximal and distal ends and defining a pliable cavity configured to encase a wearer's hand. The inner layer includes an opening at the proximal end for passing the wearer's hand therethrough to enter and exit the cavity. A cleaning layer is disposed on the inner layer such that the inner layer is between the cleaning layer and the cavity. A tab is situated and accessible from inside the cavity, the tab being operatively coupled to the inner layer and the cleaning layer such that passing the tab through the opening inverts the inner layer and the cleaning layer and undelineates the cavity. The tab is configured to be pulled by at least one finger of the wearer's hand. A fastener is positioned adjacent the opening for sealing the cleaning layer inside the inner layer.

### BRIEF DESCRIPTION OF THE DRAWINGS

FIG. 1 is a front view of a disposable cleaning mitt according to a preferred embodiment of the present invention, illustrated with a human hand inserted through a wrist opening;

FIG. 2 is a reverse perspective view of the cleaning mitt as in FIG. 1;

FIG. 3 is a sectional view taken along line 3-3 of FIG. 1;

FIG. 4 is a front view illustrating a partial inversion of the cleaning mitt according to the present invention;

FIG. 5A is a front view illustrating a complete inversion of the cleaning mitt and a fastener in a released or unsealed configuration according to the present invention; and

FIG. 5B is a front view illustrating a complete inversion of the cleaning mitt and the fastener in a sealed and disposable configuration.

### DESCRIPTION OF THE PREFERRED EMBODIMENT

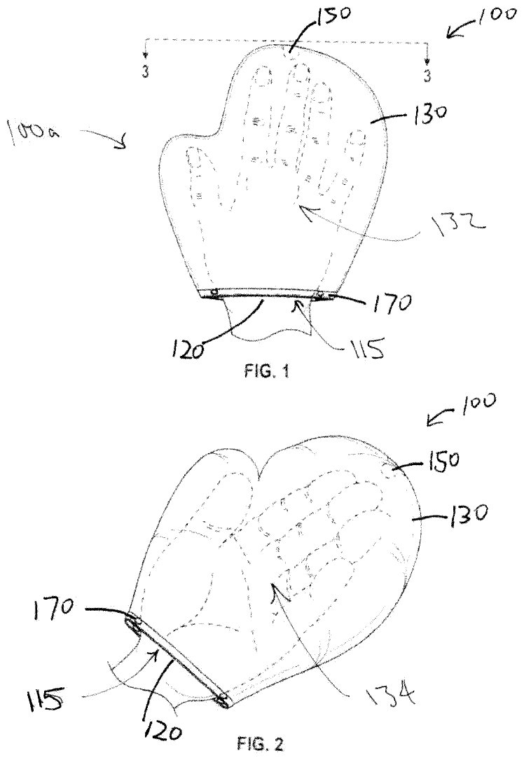

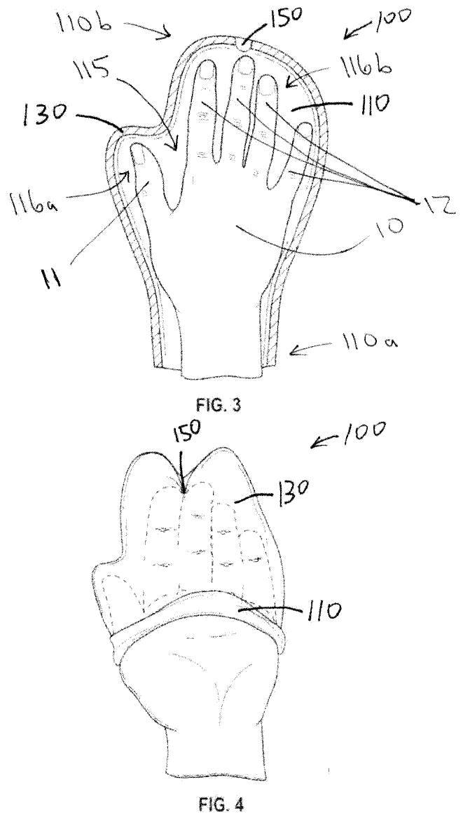

FIGS. 1 through 5B show a disposable cleaning mitt 100 according to an embodiment of the present disclosure, which may include a waterproof inner layer 110, a cleaning layer 130, a tab 150, and a fastener 170.

The inner layer 110 has a proximal end 110a and a distal end 110b and defines a pliable cavity 115 (or, generally referred to as an interior area) configured to encase a wearer's hand 10 (a wearer of the disposable cleaning mitt 100 may be referred to interchangeably herein as a “wearer” or “user”). An opening 120 is located at the proximal end 110a for passing the wearer's hand 10 therethrough to enter and exit the cavity 115. In the embodiment 100, the cavity 115 includes a thumb area 116a configured to hold the wearer's thumb 11 and a collective finger area 116b distinct from the thumb area 116a configured to hold two or more of the wearer's four fingers 12. In other embodiments, the cavity 115 may include the thumb area 116a and more (e.g., four) finger areas each distinct from the thumb area 116a to respectively hold the wearer's fingers 12.

The inner layer 110 may preferably be made of a plastic lining material or other non-porous material. It may be particularly desirable for the inner layer 110 to be made of at least one material selected from the group consisting of polyethylene, polypropylene, polyurethane, polyurea, polyester, polyolefin, polyvinyl chloride, fluoropolymer, phenol formaldehyde resin, vinyl ester, novolac vinyl ester, epoxy, and epoxy novolac.

While various sizes may be appropriate, in some embodiments the disposable inner layer 110 is sized to fit within a 6.5″×6.5″ generally rectangular perimeter when laid flat. In other respective example embodiments, the inner layer 110 is sized to fit within generally rectangular perimeters having the following dimensions when laid flat: 5″×5″, 5.5″×5.5″, 6″×6″, 7″×7″, 7.5″×7.5″, 8″×8″, 8.5″×8.5″, 9″×9″, 9.5″×9.5″, 10″×10″, 10.5″×10.5″, or 11″×11″. And in still other example embodiments, the inner layer 110 is sized to fit within a generally rectangular perimeter having dimensions of X″×Y″ with X and Y being the same or different from one another and each in the range of 5″ to 11″. The inner layer 110 may be particularly dimensioned to fully cover a wearer's entire hand 10 (including the thumb 11 and all fingers 12), or only to partially cover the wearer's hand 10.

The cleaning layer 130 is disposed on the inner layer 110 so that the inner layer 110 is positioned between the cleaning layer 130 and the cavity 115 defined by the inner layer 110. The cleaning layer 130 may have a topside 132 (e.g., to be generally positioned at a back side of the wearer's hand when the hand is in the cavity 115) and/or an underside 134 (e.g., to be generally positioned at a palm of the wearer's hand when the hand is in the cavity 115), and one or both of the topside 132 and the underside 134 may be utilized to clean a surface, a patient, a contaminant, a stain, debris, a mess, et cetera. The top side 132 and the underside 134 may be two sides of an sheet of material that is connected to the inner layer 110, may be multiple separate parts sealed together to create at least one sheet of material that is connected to the inner layer 110, and/or may be material that is coupled to the inner layer 110 without first forming a sheet. Appropriate nonexclusive materials for the cleaning layer 130 include polyester, polypropylene, cotton, wood pulp, rayon fiber, and/or wire mesh. The cleaning layer 130 may be pre-moistened and/or pre-packaged with water, isopropyl alcohol, and/or another appropriate substance.

The tab 150 is accessible from inside the cavity 115 and is operatively coupled to the inner layer 110 and the cleaning layer 130 such that passing the tab 150 through the opening 120 of the inner layer 110 inverts the inner layer 110 and the cleaning layer 130 and undelineates (i.e., destroys the boundaries of) the cavity 115. The tab 150 is configured to be pulled by at least one finger 12 of the wearer's hand 10, and it may be particularly desirable for the tab 150 to be sized and positioned to be pinched by at least two fingers 12 of the wearer's hand 10. The tab 150 may include a loop, a ring, a split, a gap, a recess, a protrusion, and/or an adhesive part configured to be pulled, pinched, inserted, pushed, and/or clicked by one or more fingers 12 of the wearer's hand 10.

It may be particularly desirable for the tab 150 to be adjacent (i.e., near or at) the distal end 111b of the inner layer 110. In various embodiments, the tab 150 may be positioned near a middle point between an index finger and a middle finger of the wearer's hand 10 inside the cavity 115. Alternately, the tab 150 may be positioned in other places such as near a middle point between a thumb and an index finger, near a middle point between a middle finger and a ring finger, and/or near a middle point between a ring finger and a pinky finger.

The fastener 170 is adjacent the opening 120 for sealing the cleaning layer 130 inside the inner layer 110. While various fasteners 170 may be utilized, it may be particularly desirable to use at least one of the following fasteners: an adhesive fastener 171 with removable cover 172, a hook and loop fastener, a twist tie, a zip tie, a grooved seam, a pull string, and a male/female coupling.

In use, the disposable cleaning mitt 100 is placed at a use configuration 100a, and the wearer's hand 10 is extended into the cavity 115 through the opening 120 (FIGS. 1 through 3). The user may then clean a target surface with the cleaning layer 120 by moving the hand 10 and the cleaning layer 120 over the target surface. As the target surface is cleaned, the waterproof inner layer 110 (which is between the cleaning layer 120 and the cavity 115) restricts a substance (e.g., a cleaning agent, bacteria, virus, et cetera) from reaching the hand 10. Once the target surface is sufficiently cleaned and the user is through with the disposable cleaning mitt 100, the disposable cleaning mitt 100 may be hygienically removed and disposed.

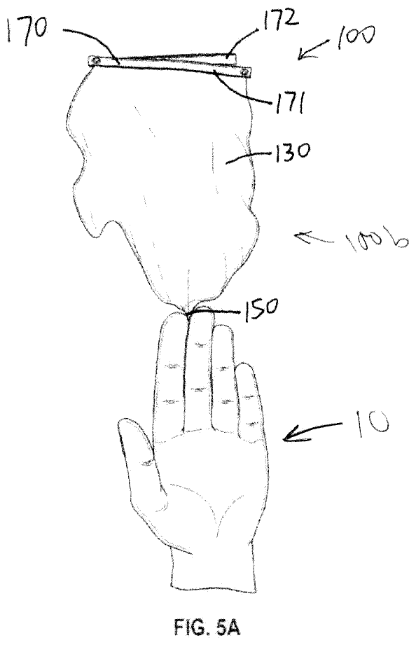

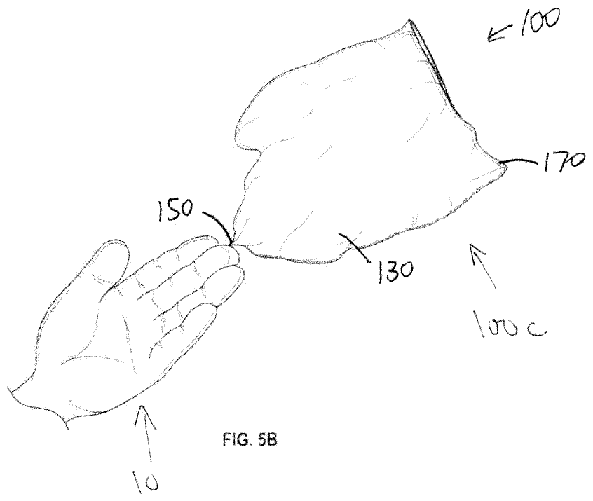

More particularly, the user may use at least one finger 12 to pull the tab 150 through the opening 120 while another hand holds the disposable cleaning mitt 100 adjacent the opening 120, thereby altering the disposable cleaning mitt from the use configuration to an inverted configuration 100b (FIGS. 4 through 5A) without exposing the hand 10 to the substance. It may be particularly desirable for the user to use two fingers (e.g., an index finger and a middle finger) to pinch the tab 150 and pull the tab 150 through the opening 120.

After the disposable cleaning mitt 100 is at the inverted configuration 100b, the fastener 170 may be used to seal the cleaning layer 130 inside the waterproof inner layer 110, placing the disposable cleaning mitt 100 at a disposal configuration 100c (FIG. 5B), and the disposable cleaning mitt 100 may be discarded.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the improvements without departing from the scope of the present disclosure. It will be understood that certain features and subcombinations are of utility and may be employed without reference to other features and subcombinations and are contemplated within the scope of the claims. Unless indicated otherwise, not all steps listed in the various figures need be carried out in the specific order described.

1. A disposable cleaning mitt for wear on a user's hand, comprising:
a waterproof inner layer having proximal and distal ends and defining a pliable cavity configured to encase a wearer's hand, said proximal end of said inner layer defining an opening for passing the wearer's hand therethrough to enter and exit said cavity;
a cleaning layer disposed on said inner layer such that said inner layer is situated between said cleaning layer and said cavity;
wherein said proximal end defining said opening is positioned proximate a base of the user's hand when the cavity is positioned on the user's hand;
a tab operatively coupled to said distal end of said inner layer and said cleaning layer and accessible from inside said cavity such that passing said tab through said opening inverts said inner layer and said cleaning layer and undelineates said cavity, said tab being configured to be pinched between a thumb and index finger of the wearer's hand and the tab pulled thereby; and
a fastener adjacent said opening for sealing said cleaning layer inside said inner layer;
wherein said inner layer is sized to fit within a rectangular perimeter having dimensions between 5″×5″ and 11″×11″ when laid flat.

2. (canceled)

3. The disposable cleaning mitt of claim 1, wherein said fastener includes at least one fastener selected from the group consisting of: an adhesive fastener, a hook and loop fastener, a twist tie, a zip tie, a grooved seam, a pull string, and a male/female coupling.

4. The disposable cleaning mitt of claim 1, wherein said inner layer includes at least one material selected from the group consisting of: polyethylene, polypropylene, polyurethane, polyurea, polyester, polyolefin, polyvinyl chloride, fluoropolymer, phenol formaldehyde resin, vinyl ester, novolac vinyl ester, epoxy, and epoxy novolac.

5. The disposable cleaning mitt of claim 1, wherein said cleaning layer includes at least one item selected from the group consisting of: polyester, polypropylene, cotton, wood pulp, and rayon fiber.

6. The disposable cleaning mitt of claim 5, wherein said cleaning layer is pre-moistened with at least one item selected from the group consisting of: water and isopropyl alcohol.

7. The disposable cleaning mitt of claim 1, wherein said cleaning layer includes a wire mesh.

8. A disposable cleaning mitt having a use configuration, an inverted configuration, and a disposal configuration, said disposable cleaning mitt consisting of:
a waterproof layer having proximal and distal ends and defining a pliable cavity when said disposable cleaning mitt is at said use configuration, said cavity being configured to encase a wearer's hand, said proximal end of said waterproof layer defining an opening for passing said hand therethrough to enter and exit said cavity when said disposable cleaning mitt is at said use configuration;
a cleaning layer adjacent said waterproof layer such that said waterproof layer is between said cleaning layer and said cavity when said disposable cleaning mitt is at said use configuration;
wherein said proximal end defining said opening is positioned proximate a base of the user's hand when the disposable cleaning mitt is at said use configuration and the cavity is positioned on the user's hand;
wherein said inner layer is sized to fit within a rectangular perimeter having dimensions between 5″×5″ and 11″×11″ when laid flat;
wherein said cleaning layer includes a wire mesh;
a tab accessible from inside said cavity when said disposable cleaning mitt is at said use configuration; said tab being coupled to said distal end of said waterproof layer and said cleaning layer such that passing said tab through said opening inverts said waterproof layer and said cleaning layer, thereby altering said disposable cleaning mitt from said use configuration to said inverted configuration; said tab being sized and positioned to be pinched by two fingers of said wearer's hand and pulled thereby; and
a fastener adjacent said opening for sealing said cleaning layer inside said waterproof layer, thereby altering said disposable cleaning mitt from said inverted configuration to said disposal configuration.

9. (canceled)

10. (canceled)

11. (canceled)

12. The disposable cleaning mitt of claim 8, wherein:
said waterproof layer includes at least one item selected from the group consisting of: polyethylene, polypropylene, polyurethane, polyurea, polyester, polyolefin, polyvinyl chloride, fluoropolymer, phenol formaldehyde resin, vinyl ester, novolac vinyl ester, epoxy, and epoxy novolac; and
said cleaning layer includes at least one item selected from the group consisting of: polyester, polypropylene, cotton, wood pulp, rayon fiber, and wire mesh.

13. The disposable cleaning mitt of claim 8, wherein said fastener includes at least one fastener selected from the group consisting of: an adhesive fastener, a hook and loop fastener, a twist tie, a zip tie, a grooved seam, a pull string, and a male/female coupling.

14. The disposable cleaning mitt of claim 8, wherein said cavity includes a thumb area and a collective finger area distinct from said thumb area.

15. The disposable cleaning mitt of claim 8, wherein said cavity includes a thumb area and four finger areas each distinct from said thumb area.

16. A method of using a disposable cleaning mitt, said method consisting of:
providing a cleaning mitt having:
a waterproof layer with proximal and distal ends and defining a pliable cavity when said disposable cleaning mitt is at a use configuration, said cavity being configured to encase a wearer's hand, said proximal end of said waterproof layer defining an opening for passing said hand therethrough to enter and exit said cavity when said disposable cleaning mitt is at said use configuration;
a cleaning layer adjacent said waterproof layer such that said waterproof layer is between said cleaning layer and said cavity when said disposable cleaning mitt is at said configuration;
a tab accessible from inside said cavity when said disposable cleaning mitt is at said use configuration; said tab being operatively coupled to said distal end of said waterproof layer and said cleaning layer such that passing said tab through said opening inverts said waterproof layer and said cleaning layer, thereby altering said disposable cleaning mitt from said use configuration to an inverted configuration; said tab being configured to be pulled by at least one finger of said wearer's hand; and
an adhesive fastener adjacent said opening for closing said opening, thereby altering said disposable cleaning mitt from said inverted configuration to a disposal configuration;
while said disposable cleaning mitt is at said use configuration, extending said wearer's hand into said cavity via said opening, wherein said waterproof layer has terminal edges proximate a base of the wearer's hand when the wearer's hand is extended into said cavity;
cleaning a target surface with said cleaning layer by moving said hand and said cleaning layer over said target surface, said waterproof layer restricting a substance from reaching said hand, said substance being at least one item selected from the group consisting of a cleaning agent, bacteria, and virus;
using two fingers to pinch said tab and pulling said tab through said opening while another hand holds said disposable cleaning mitt adjacent said opening, thereby altering said disposable cleaning mitt from said use configuration to said inverted configuration and also removing said at least one finger from said cavity without exposing said at least one finger to said substance;
wherein said two fingers are an index finger and a middle finger;
sealing said opening using said fastener thereby altering said disposable cleaning mitt from said inverted configuration to said disposal configuration; and
discarding said disposable cleaning mitt.

17. The method of claim 16, wherein:
said waterproof layer includes at least one item selected from the group consisting of: polyethylene, polypropylene, polyurethane, polyurea, polyester, polyolefin, polyvinyl chloride, fluoropolymer, phenol formaldehyde resin, vinyl ester, novolac vinyl ester, epoxy, and epoxy novolac; and
said cleaning layer includes at least one item selected from the group consisting of: polyester, polypropylene, cotton, wood pulp, rayon fiber, and wire mesh.

18. (canceled)

19. (canceled)

20. The method of claim 16, wherein said step of sealing said opening using said fastener includes taking at least one action selected from the group consisting of: adhering, connecting a hook and loop fastener, twisting a tie, decreasing a diameter of a cable tie, and fastening a male/female coupling.
